(19) United States
(12) Patent Application Publication
(10) Pub. No.: US 2005/0132028 A1
(43) Pub. Date: Jun. 16, 2005

(54) Automated image forming device configuration

(76) Inventors: Samuel M. Lester, Boise, ID (US); Jimmy Sfaelos, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,982

(22) Filed: Dec. 11, 2003

(51) Int. Cl. G06F 15/177; G06F 15/173

(52) U.S. Cl. 709/222; 709/224

(57) ABSTRACT

Methodology, systems, and media associated with automatically configuring an image forming device to process alerts are described. One exemplary system may include an image forming device configured to communicate setup data with a configuration server and to selectively configure the image forming device based, at least in part, on the setup data.

### BACKGROUND

Some image forming devices, like laser printers, may have a processor, memory, and computer executable instructions that facilitate communicating data and/or computer executable instructions between co-operating sets of devices. These image forming devices may be referred to as being “web-enabled”. For example, a printer may include a Java Virtual Machine (JVM) that facilitates running various processes that interpret Java instructions. Some of these processes may communicate with other computers via networks like the Internet and/or World Wide Web (Web). These processes may be manually configured with information like the Internet Protocol (IP) address and/or Uniform Resource Locator (URL) of the computer with which the printer desires to communicate. But printer users may not desire to perform configuration tasks, may not know how to perform the configuration tasks, and may not be able to react to unexpected problems with the printers.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example configuration system.

FIG. 2 illustrates an example configuration server.

FIG. 3 illustrates an example configuration system.

FIG. 4 illustrates an example method for auto-configuring an image forming device to process alerts.

FIG. 5 illustrates an example method for automatically providing configuration information to an alert generating printer.

FIG. 6 illustrates an example method for auto-configuring an image forming device.

FIG. 7 illustrates an example method for automatically providing configuration information to an alert generating printer.

FIG. 8 illustrates an example computing environment in which example alert configuration systems and methods can operate.

FIG. 9 illustrates an example image forming device in which example alert configuration systems and methods can operate.

FIG. 10 illustrates an example data packet.

FIG. 11 illustrates example sub-fields in a data packet.

FIG. 12 illustrates a simulated screen shot from a user interface.

FIG. 13 illustrates an example system for automatically configuring a printer.

### DETAILED DESCRIPTION

This application describes example systems, methods, computer-readable mediums and so on associated with automatically configuring an image forming device that generates alerts associated with device events. An alert can be, for example, an email, a page, a cellular telephone call, an interrupt, a signal, and so on generated in response to an event occurring on the image forming device. The image forming device may be configured to interact with a communication server that may, for example, distribute electronic mail messages (emails) about the device events to various recipients. The example systems, methods, computer-readable mediums and so on facilitate automatically rather than manually setting up a device like a printer so that alerts concerning events like the toner being low can be sent over networks like the Internet to various recipients like technical support personnel. Example systems can include components associated with the printer, with a configuration server, with a posting server, and/or with a communication server. In one example, the configuration server, posting server, and/or communication server can be implemented in one computer.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Address”, as used herein, includes but is not limited to one or more communication network accessible addresses, device identifiers, IP (Internet Protocol) addresses, URLs and FTP (File Transfer Protocol) locations or the like, network drive locations, a globally unique identifier (GUID), or other types of addresses that can identify a desired destination or device.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, an application specific integrated circuit (ASIC), a compact disc (CD), a digital video disk (DVD), a random access memory (RAM), a read only memory (ROM), a programmable read only memory (PROM), an electronically erasable programmable read only memory (EEPROM), a disk, a carrier wave, a memory stick, a floppy disk, a flexible disk, a hard disk, a magnetic tape, other magnetic media, a CD-ROM, other optical media, punch cards, paper tape, other physical media with patterns of holes, an EPROM, a FLASH-EPROM, or other memory chip or card, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an ASIC, a programmed logic device, a memory device containing instructions, or the like. Logic may also be fully embodied as software.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend on, for example, requirements of a desired application, the environment in which it runs, and/or the desires of a designer/programmer or the like. It will also be appreciated that computer-readable and/or executable instructions can be located in one or more communicating, co-operating, and/or parallel processing computers and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, machine, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, processor, or similar electronic device that manipulates and transforms data represented as physical (electronic) quantities.

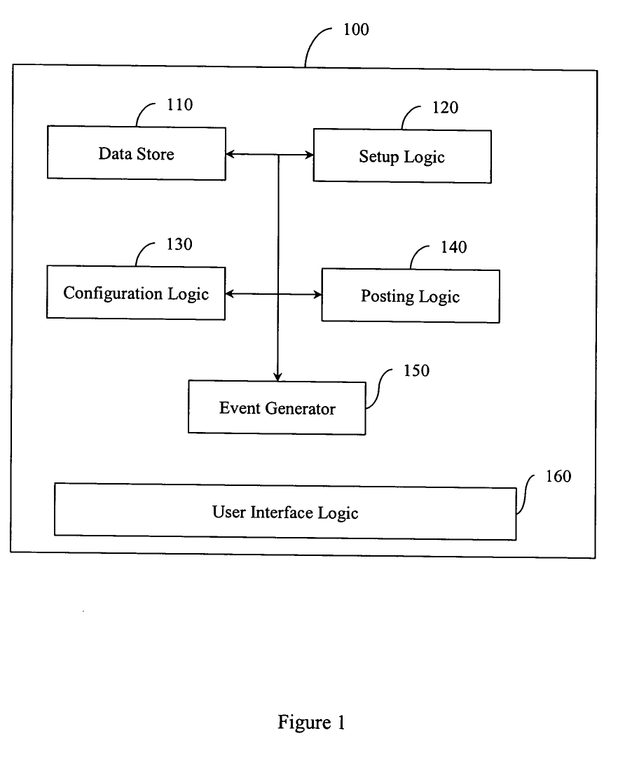

FIG. 1 illustrates a system 100 that facilitates automatically configuring an image forming device to process alerts. Executable components of the system 100 may be stored, for example, on a computer-readable medium. In one example, executable components and data stores associated with the system 100 may be installed in the image forming device. For example, executable components and data stores of the system 100 may be embodied as an ASIC or an EPROM that can be installed into the image forming device. The image forming device may be, for example, a printer. In one example, the printer is a laser jet printer. The alerts may be associated with device events including, but not limited to, a low toner situation, a toner empty situation, a paper jam, the printer overheating, a print job being interrupted, a print job completing, the printer coming online, the printer going offline, and the like. The image forming device may seek to alert certain users about these device events. For example, if the toner is low, the printer may want to alert a technical support person to refill the toner and a purchasing agent to order some more toner. Similarly, if a device event reports that the printer is approaching a printing landmark (e.g., 10,000 pages printed) then the printer may wish to notify qualified service personnel to come out and clean the printer. The alert may be sent, for example, as an email over the Internet and/or Web.

A web-enabled printer may, for example, include a logic that enables the printer to communicate data and/or computer executable instructions between co-operating sets of devices In one example, the web-enabled image forming device may include a logic for processing Java instructions. Thus, in one example, the web-enabled image forming device and/or the system 100 may include a Java Virtual Machine (JVM) that facilitates communicating across the Internet and/or Web. The JVM may process Java instructions for configuring the web-enabled image forming device. Being web-enabled, the printer may attempt to contact people, and/or processes via, for example, an email message. Thus, in one example, the system 100 facilitates configuring a printer to communicate, via a posting server, with a communication server like a Simple Mail Transfer Protocol (SMTP) server that will distribute electronic communications (e.g., email) associated with an event that occurs on the printer.

The system 100 may include a data store 110 that is configured to store addresses of various servers. For example, the data store 110 may store the address of a configuration server that the system 100 interacts with to find, for example, posting servers, communication servers, and so on. The data store 110 may also store the address of a posting server to which alerts concerning an event may be sent. Similarly, the data store 110 may store the address of a communication server that may distribute an electronic communication like an email generated in response to the alert being posted to the posting server. The addresses may be, for example, hard coded into the data store 110, manually entered into the data store 110, and/or written into the data store 110 by startup and/or setup processes that acquire the addresses from, for example, a configuration server. The addresses may be, for example, URLs, IP addresses, and the like. Establishing and re-establishing the addresses of the various servers is an operation that is performed manually in some systems. However, users may not desire to program these addresses manually, if they are even capable of doing so. Thus, in one example, the system 100 facilitates (re)establishing these addresses automatically by the operation of a setup logic 120, a configuration logic 130, and/or a posting logic 140.

The system 100 may include a setup logic 120 that is configured to communicate setup data between an image forming device and a configuration server. The setup data may facilitate configuring the web-enabled image forming device and/or the configuration server with respect to processing alerts. Thus, the setup data may include, for example, an alert type identifier, a set of alert recipient identifiers, an image forming device address, a posting server address, a communication server address and the like. In one example the setup data may be Extensible Markup Language (XML) data. Setup data can be sent from the system 100 to a configuration server and/or received in the system 100 from the configuration server. For example, when the image forming device is powered up, the setup logic 120 may communicate an IP address of the image forming device to a configuration server. In one example, the data may be sent to the configuration server via a HyperText Transfer Protocol (HTTP) post message. Additionally, the setup logic 120 may communicate information concerning the degree to which the image forming device is to be automatically configured. Choices may include, for example, manually configuring the image forming device, having executable components of the system 100 present choices to an image forming device and/or user, and having executable components of the system 100 substantially completely control the configuration. By way of illustration of substantially complete control, the system 100 may select posting servers to receive posting data and may also select communication servers to distribute electronic communications like emails concerning the posting data. Then the system 100 may automatically configure the printer to employ the selected servers for alert distribution.

The system 100 may include a configuration logic 130 that is configured to automatically configure the image forming device to process alerts based, at least in part, on the setup data. For example, setup data returned from a configuration server may include the address of posting servers to which the image forming device is to be configured to transmit posting data. The posting data may, for example, facilitate communicating information associated with an alert. By way of illustration, the posting data may include, an alert type, an alert data, a set of alert recipient identifiers, an image forming device address, a posting acknowledgment, and the like. In one example, the posting data may be XML data. In another example, the posting data may include the email address(es) of the parties to be sent an email concerning the device event that triggered the posting data being transmitted.

Thus, the configuration logic 130 may select a posting server to which posting data is to be sent and then automatically configure the image forming device to post the posting data to the selected posting server. In one example, the configuration logic 130 may (re)configure the image forming device by changing a posting server address in the data store 110. Similarly, the configuration logic 130 may select a communication server to distribute an electronic communication (e.g., email) produced in response to the posting server receiving the posting data. Thus, the configuration logic 130 may automatically configure the image forming device to direct the selected posting server to utilize the selected communication server. In one example, the configuration logic 130 may (re)configure the image forming device by changing a communication server address in the data store 110.

The system 100 may, in some examples, also include a posting logic 140 that is configured to selectively communicate the posting data between the image forming device and the posting server. However, some example systems 100 may not include a posting logic 140 as part of the configuration system. In other examples, a posting logic 140 may already be present in an image forming device and thus the system 100 may therefore employ the existing posting logic 140.

The system 100 facilitates configuring the image forming device to process alerts. Configuring the image forming device may include establishing a level of user interaction in the configuration process. Establishing the level may include presenting a user interface and receiving user choices about automatic alert configuration through the user interface. Thus, in one example, the system 100 may include a user interface logic 160 configured to facilitate communicating configuration information between a user and the system. In another example the system may employ the user interface logic 160 to facilitate actions including, but not limited to, a user selecting a discovered posting server with which the posting data will be communicated and selecting a discovered communication server to distribute an electronic communication associated with the posting data. In yet another example, to facilitate diagnostic testing, installation testing, and the like, the system 100 may include an event generator 150 that facilitates simulating device events.

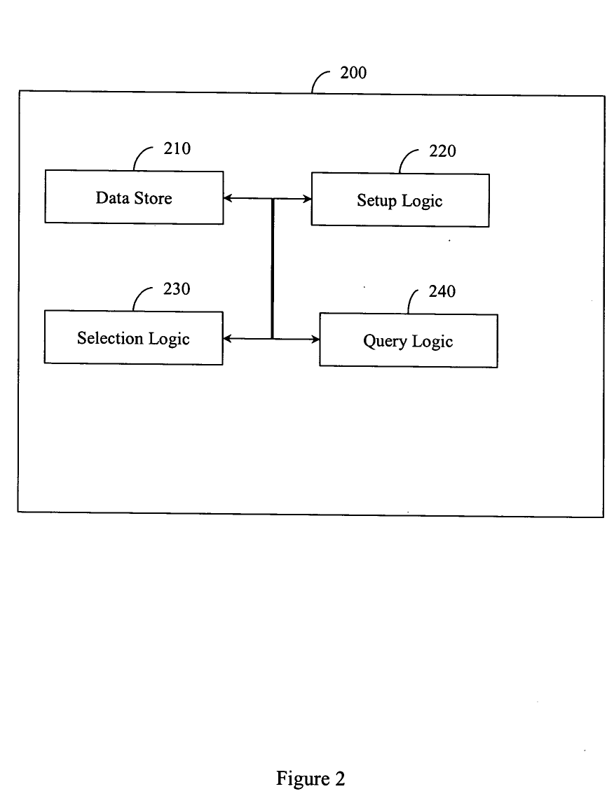

FIG. 2 illustrates an example configuration server 200 that may participate in automatically configuring an image forming device to process alerts. The system 200 may be configured to be installed in, for example, a configuration server. The image forming device may generate alerts associated with device events and thus may undergo configuration concerning various servers employed to deliver the alerts. For example, the device may be configured with respect to communication servers that can distribute electronic communications associated with the alert and posting servers to which alert data can be posted.

The system 200 may receive configuration requests and/or alerts from, for example, a printer. The alerts may be associated with printer device events including, but not limited to, a toner low state, a toner empty state, a paper jam state, an overheating state, a print job interrupted state, a print job completed state, an online state, and an offline state. The configuration requests may be associated with items including, but not limited to, discovering and/or recommending posting servers and discovering and/or recommending communication servers.

Thus, the system 200 may include a data store 210 configured to store addresses like the address of a printer being configured, the address of a posting server and/or the address of a communication server. The addresses may be, for example, URLs, IP addresses, email addresses, and so on.

The system 200 may also include a setup logic 220 configured to communicate a setup data with the image forming device. The setup data may facilitate configuring the image forming device and/or the system 200 by carrying information about, for example, configuration requests, discovered servers, recommended servers, and the like. The setup data may flow back and forth between the setup logic 220 and the image forming device. The setup data may include, for example, an alert type identifier, a set of alert recipient identifiers, an image forming device address, a posting server address, and a communication server address. The alert type identifier may indicate what types of alerts the image forming device will generate. The set of alert recipient identifiers may include the email addresses of users that will receive email messages associated with the alerts concerning various device events. The posting server address may include addresses of posting servers that the system 200 may report to the image forming device as being available to receive posting data. Similarly, the communication server address may include addresses of communication servers like SMTP servers that are available to distribute electronic messages like emails that report the device event associated with the alert.

The system 200 may also include a selection logic 230. The selection logic 230 may be configured to select a posting server that can provide alert posting services for the image forming device. Thus, the selection logic 230 may also be configured to automatically configure the image forming device to post posting data to the selected posting server. For example, the selection logic 230 may send a command and/or address to the image forming device concerning the identity of the selected posting server. The selection logic 230 may also be configured to select a communication server that will provide an electronic communication distribution service for the image forming device. Thus, the selection logic 230 may also be configured to automatically configure the image forming device to direct the selected posting server to utilize the electronic communication distribution services of the selected communication server. The selection logic 230 may select the posting server(s) and/or communication server(s) based, at least in part, on the setup data. For example, the setup data from the image forming device may indicate that alerts are to be sent to recipients in the Western United States. Thus, posting servers and/or communication servers may be selected to optimize, for example, transmission time to that geographic region.

While in some examples the system 200 may generally have information pushed to it from an image forming device, in one example the system 200 may attempt to pull information from an image forming device. By way of illustration, in one example, the system 200 may include a query logic 240 configured to query the image forming device for non-alert posting data like usage data, status data, trend data and so on. If the query logic 240 pulls this type of information from the image forming device, the query logic 240 may then generate a non-alert message based, at least in part, on the data. By way of illustration, the query logic 240 may periodically query an image forming device concerning how many pages it has printed. When a landmark number of pages is approaching (e.g., 10,000 pages), the query logic 240 may generate a preventative type message to a service technician who may schedule a cleaning and tune-up for the printer. While a landmark event is described, it is to be appreciated that other non-alert type messages could be generated.

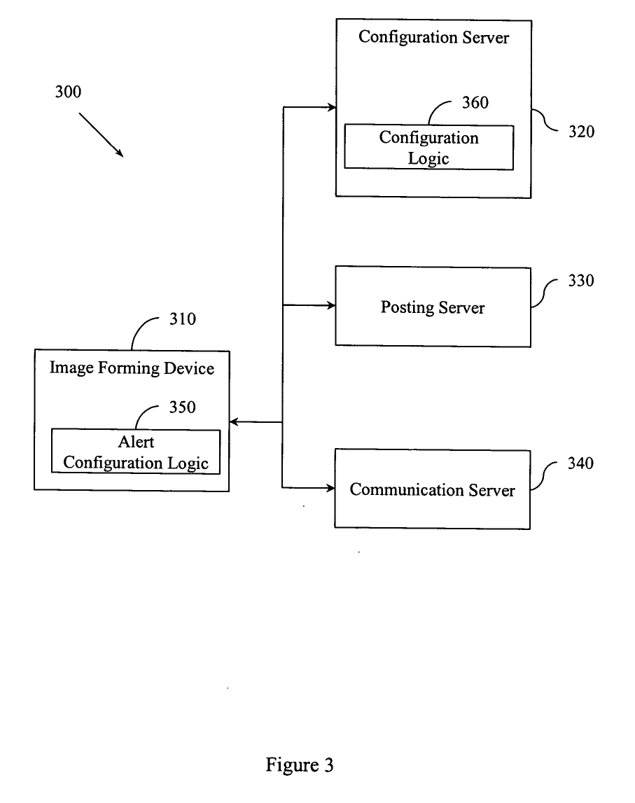

FIG. 3 illustrates a system 300 that includes an image forming device 310 interacting with a configuration server 320. The image forming device 310 may be, for example, a web-enabled device that can process instructions like Java instructions. FIG. 3 also illustrates a posting server 330, and a communication server 340. While the configuration server 320, posting server 330, and communication server 340 are illustrated as separate entities, it is to be appreciated that in some examples these servers may be implemented in a single computer and/or logic.

The image forming device 310 may include an alert configuration logic 350 that is configured to automatically configure the image forming device 310 to process alerts. The alert configuration logic 350 may include a memory that stores, for example, the address of and/or parameters describing a configuration server(s) 320 involved in configuring the image forming device 310, the address of and/or parameters describing a posting server(s) 330 to which the image forming device 310 may be configured to send posting data, and the address of and/or parameters describing a communication server(s) 340 that the image forming device 310 has been configured to direct the posting server to employ. In one example, a configuration server address may be pre-established in the memory and thus, on start-up, the image forming device 310 can communicate with that configuration server 320 to begin the configuration process.

The alert configuration logic 350 may also include a setup logic that is configured to communicate setup data between the image forming device 310 and the configuration server 320. The setup data facilitates configuring the web-enabled image forming device 310 and/or the configuration server 320. The setup data, which may flow both ways between the alert configuration logic 350 and the configuration server 320 may include, for example, server addresses, server parameters, communication protocol parameters, and so on. The setup data may be communicated via an HTTP post, for example.

The alert configuration logic 350 may also include a configuration logic that may be configured to facilitate automatically configuring the image forming device 310 to process alerts. How the image forming device 310 is configured by the configuration logic may depend on the setup data. Configuring the image forming device 310 to process alerts can include, for example, establishing a level of user interaction in the configuration process. By way of illustration, the user may manually configure the image forming device 310 with server addresses, communication parameters and so on, or the system 300 may substantially completely control configuring the image forming device 310, with various degrees of user/system cooperation falling in-between these end points.

Configuring the image forming device 310 to process alerts can also include identifying and/or selecting servers to provide various services. Thus, the alert configuration logic 350 may be configured to select a posting server(s) 330 to which the image forming device 310 can send posting data and to select a communication server(s) 340 that will distribute electronic communications associated with the posting data. The alert configuration logic 350 may also be configured to automatically configure the image forming device 310 to distribute posting data to the selected posting server 330 and to direct the posting server 330 to employ the selected communication server 340. The automatic configuration may involve, for example, updating addresses and/or parameters that other systems may require a user to manipulate manually.

The configuration server 320 may include a configuration logic 360 that includes a setup logic for communicating the setup data (e.g., server addresses/parameters) to the image forming device 310. The configuration logic 360 may also include a selection logic that facilitates selecting servers like posting server(s) 330 and communication server(s) 340 to provide services like alert services and electronic communication distribution services for the image forming device 310. The electronic communication distribution services may be implemented, for example, in an SMTP server. Which services are selected may depend, for example, on the setup data. By way of illustration, the setup data may indicate an anticipated volume of alert traffic. Thus, a server(s) that can efficiently and/or economically handle this volume of traffic may be selected.

In one example, when the configuration server 320 and the posting server 330 are implemented in the same computer, the configuration logic 360 may also include a translation logic that facilitates receiving posting data associated with an alert and generating an electronic communication like an email message from the posting data. For example, the translation logic may receive XML data in an HTTP post and generate an SMTP message from the XML data. Similarly, when the configuration server 320 and the posting server 330 are implemented in the same computer, the configuration logic 360 may also include a communication logic configured to communicate the electronic communication (e.g., email message) to a communication server (e.g., server 340).

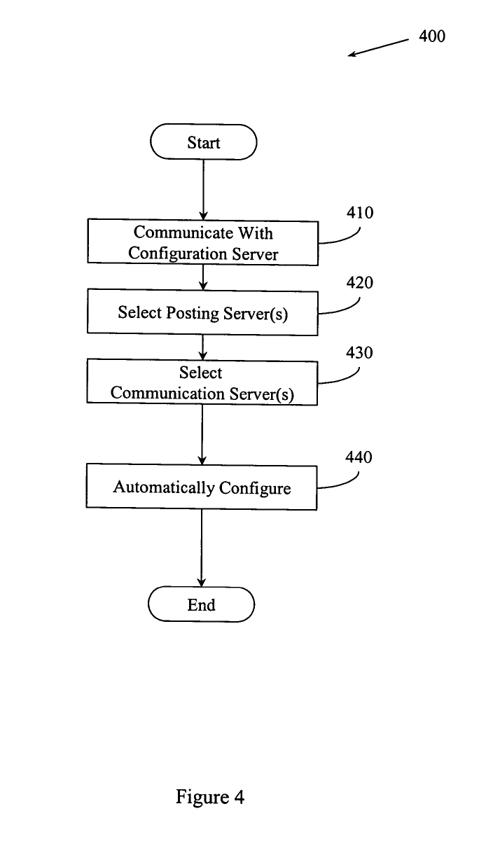

Example methods may be better appreciated with reference to the flow diagrams of FIGS. 4, 5, 6, and 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as processor executable instructions and/or operations stored on a computer-readable medium.

In the flow diagrams, blocks denote “processing blocks” that may be implemented, for example, in software. Additionally and/or alternatively, the processing blocks may represent functions and/or actions performed by functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to fabricate circuits, generate software, or use a combination of hardware and software to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 4 illustrates an example method 400 for automatically configuring an image forming device to process alerts. The method 400 may include, at 410, communicating a startup data with a configuration server. The startup data may facilitate identifying an image forming device and/or alert processing to be performed by a configuration server and/or the image forming device. The startup data may include, for example, the address of the printer for which the method 400 is being executed, the type of alerts that will be generated, the email addresses of recipients for the various types of alerts, and the like.

The method 400 may also include, at 420, selecting a posting server(s) to which alert data associated with a device event will be posted. The alert data may include, for example, an alert identifier, an alert type, an alert message, and an alert recipient. The posting server selection may be based, at least in part, on the startup data. For example, the startup data may have included a set of posting servers to which data could be sent. The method 400 may therefore choose between the posting servers. Alternatively and/or additionally, the startup data may have indicated an anticipated volume of posting data and thus a posting server(s) may be selected to economically and/or efficiently handle the anticipated volume.

Similarly, the method 400 may include, at 430, selecting a communication server(s) to distribute electronic notifications generated in response to the alert data being posted to the posting server. Which communication server(s) is chosen may be based, at least in part, on the startup data. For example, the startup data may have included a set of SMTP servers that could distribute email. The method 400 may therefore choose one or more of the available SMTP servers.

Once a posting server is selected and a communication server is selected, the method 400 may include, at 440, automatically configuring the image forming device for which the method 400 is being executed to post alert data to the selected posting server and to direct the selected posting server to employ the selected communication server.

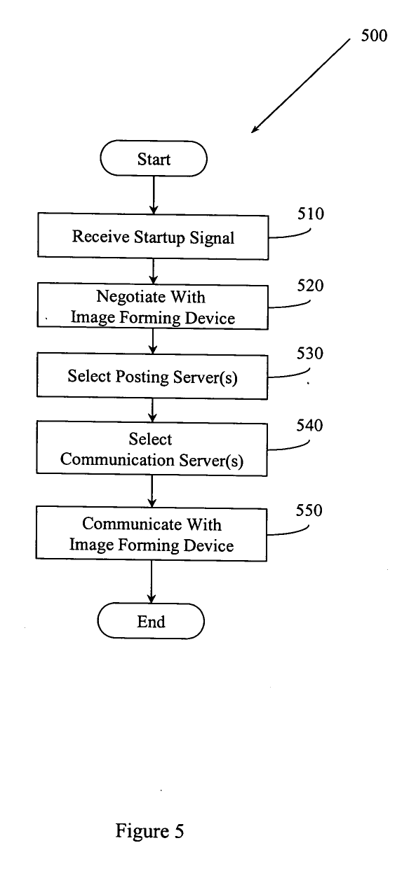

FIG. 5 illustrates an example method 500 for automatically providing configuration information to an alert generating printer. In one example the printer may be web-enabled. The method 500 may include, at 510, receiving a startup signal from the printer. The method 500 may also include, at 520, negotiating a level of automatic configuration service for the image forming device. The level may range from, for example, fully manual configuration to fully automatic configuration. The method 500 may also include, at 530, selecting a posting server(s) to provide an alert posting service for the image forming device. The method 500 may also include, at 540, selecting a communication server(s) to provide an electronic message distribution service for the image forming device.

The method 500 may also include, at 550, communicating information with the image forming device. The information may include, for example, the address and/or capability of various posting and/or communication servers that were located and selected at 530 and 540.

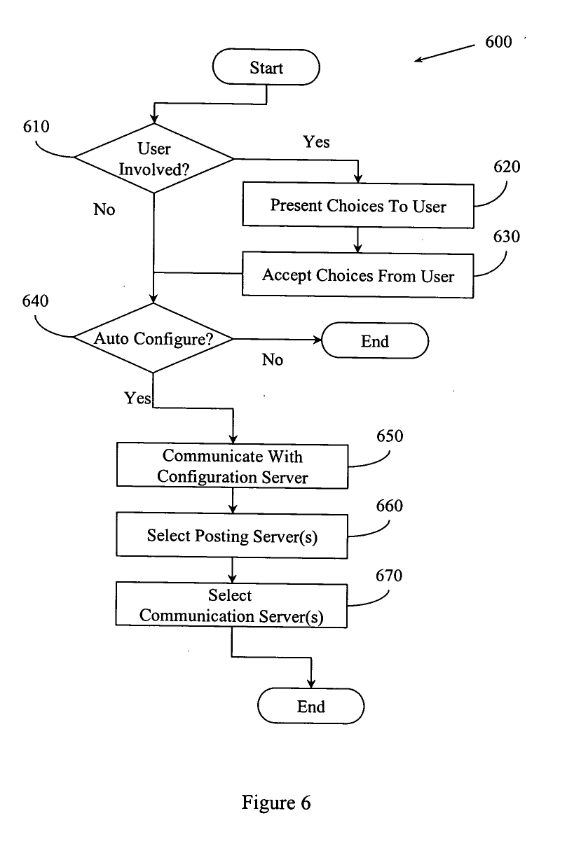

FIG. 6 illustrates an example method 600 for automatically configuring an image forming device to process alerts. The method 600 may include, at 610, determining the degree to which a user will be involved with the configuration. The degree may range from completely manual configuration to partially automatic configuration (e.g., find and report available services) to substantially complete automatic configuration. If the determination at 610 is that the user will not be involved, processing proceeds at 640. But if the determination at 610 is Yes, that the user will be involved, then the method 600 may include, at 620, presenting one or more choices to a user and, at 630, accepting the choices from the user. The user may enter, for example, the IP address of an SMTP server to distribute electronic communications associated with alerts, a domain name associated with the image forming device and/or SMTP server, and a device email address associated with the image forming device and/or SMTP server. It is to be appreciated that other user choices could be offered and accepted. Thus, the user may be involved in providing some information, even in an automated configuration process.

At 640, a determination is made concerning whether the system will be automatically configured. If the determination is No, then processing may conclude. But if the determination is Yes, then processing may proceed to 650. It is to be appreciated that some methods may not include the steps 610 through 640, and may be configured to automatically begin at a step like step 650. By way of illustration, a printer may be programmed to communicate with a configuration server when the printer starts up. The URL and/or IP address of the configuration server may be stored in the printer.

The method 600 may include, at 650, communicating a startup data with a configuration server. The startup data may include, for example, the address of the printer that is executing the method 600, the type of alerts that will be generated, the email addresses of recipients for the various types of alerts, and the like.

The method 600 may also include, at 660, selecting a posting server(s) to which alert data will be posted. The alert data may be, for example, XML data that is sent by an HTTP message. The alert data may include, for example, an alert identifier, an alert type, an alert message, and an alert recipient. The selection may be based, at least in part, on the startup data. For example, the startup data may have included a set of posting servers to which data could be sent. The method 600 may therefore choose one or more of the posting servers to employ. Alternatively and/or additionally, the startup data may have indicated an anticipated volume of posting data and thus a posting server(s) may be selected to economically and/or efficiently handle the anticipated volume.

Similarly, the method 600 may include, at 670, selecting a communication server(s) to distribute electronic notifications generated from the alert data posted to the posting servers. Which communication server(s) is chosen may be based, at least in part, on the startup data. For example, the startup data may have included a set of SMTP servers that could distribute email. The method 600 may therefore choose one or more of the available SMTP servers. Additionally and/or alternatively, the startup data may have included recipient identifying data. Thus, SMTP servers with high speed access to those recipients may be selected.

While FIG. 6 illustrates various actions occurring in serial, it is to be appreciated that various actions illustrated in FIG. 6 could occur substantially in parallel. By way of illustration, a first process could interact with a configuration server to communicate (e.g., transmit/receive) setup data. Similarly, a second process could select posting servers based, for example, on dynamic real-time considerations (e.g., current load, historical reliability) and a third process could select communication servers based on similar real-time considerations. While three processes are described, it is to be appreciated that a greater and/or lesser number of processes could be employed and that lightweight processes, regular processes, threads, and other approaches could be employed.

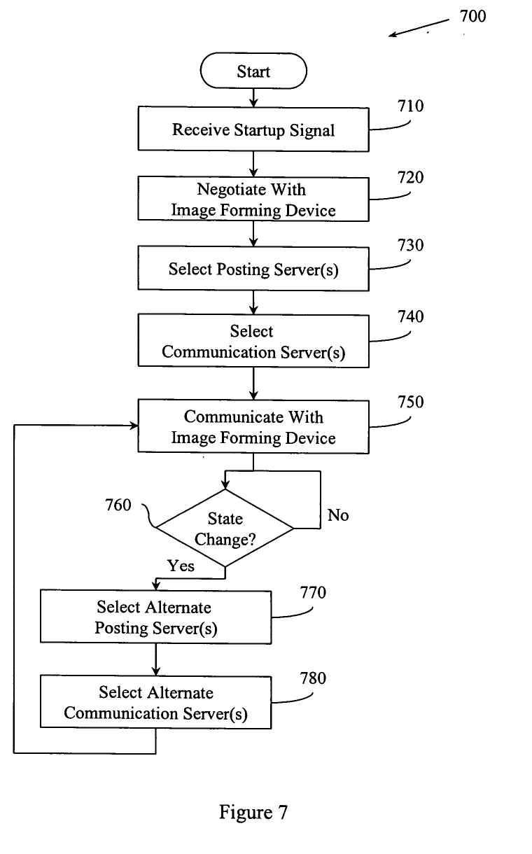

FIG. 7 illustrates an example method 700 for automatically providing configuration information to an alert generating printer. The method 700 may include, at 710, receiving a startup signal from the printer. The startup signal may be, for example, an interrupt, a message (e.g., HTTP post), an email, and the like. The method 700 may also include, at 720, negotiating a level of automatic configuration service for the image forming device. The level may range from, for example, fully manual configuration to fully automatic configuration. In one example the partially automatic level includes detecting servers (e.g., posting server, communication server) and then recommending servers to a user who will manually select from the detected servers.

The method 700 may also include, at 730, selecting a posting server(s) to provide an alert posting service for the image forming device. The alert posting service may include, for example, receiving XML data concerning an alert and generating an email message from the XML data. The method 700 may also include, at 740, selecting a communication server(s) to provide an electronic message distribution service for the image forming device. The electronic message distribution service may include, for example, sending an email message via an SMTP server.

The method 700 may also include, at 750, communicating information with the image forming device. The information may include, for example, the address and/or capability of various posting and/or communication servers that were located and selected at 730 and 740. While FIG. 7 illustrates steps 710 through 780, it is to be appreciated that one example method could include fewer steps.

In one example, the method 700 may also include, at 760, detecting a state change in a posting server and/or a communication server. If no state change is determined, then the method may, for example, sleep and/or loop until a state change is detected and/or until the method is terminated. If a state change is detected at 760, then the method 700 may include, at 770, selecting an alternate posting server and/or at 780 selecting an alternate communication server. By way of illustration, if the state change indicated that a posting server being used by the image forming device went down, then a different posting server may be located and selected to replace the downed posting server. Since a posting server may have a set of preferred communication servers, in one example selecting an alternate posting server may also include selecting an alternate communication server.

With the alternate posting and/or communication server selected, the method 700 may then return to 750 where a reconfiguration data related to the state change, the alternate posting server and/or the alternate communication server may be communicated to the image forming device.

While FIG. 7 illustrates various actions occurring in serial, it is to be appreciated that various actions illustrated in FIG. 7 could occur substantially in parallel. By way of illustration, a first process could detect startup signals, a second process could select posting servers, a third process could select communication servers, and a fourth process could communicate with the image forming device. While four processes are described, it is to be appreciated that a greater and/or lesser number of processes could be employed and that lightweight processes, regular processes, threads, and other approaches could be employed.

In one example, a computer-readable medium may store processor executable instructions operable to perform a method for automatically configuring an image forming device for alert distribution. The method may include, for example, communicating startup data with a configuration server, selecting a posting server to which alert data will be posted, and selecting a communication server to distribute electronic notifications generated from the alert data posted to the posting servers. While one method is described, it is to be appreciated that other computer-readable mediums could store other example methods described herein.

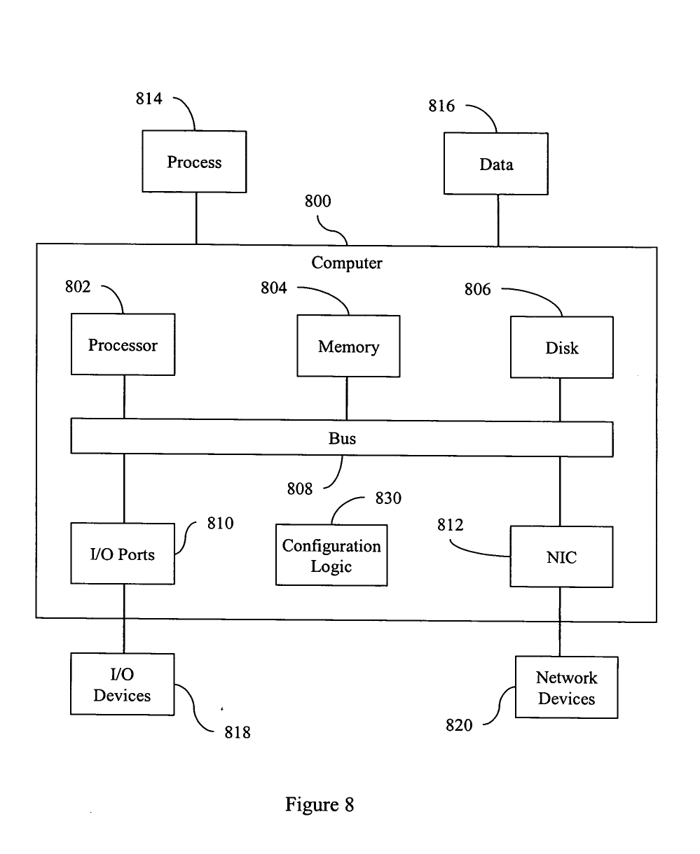

FIG. 8 illustrates a computer 800 that includes a processor 802, a memory 804, and input/output ports 810 operably connected by a bus 808. Executable components of example systems described herein may be located in computer 800. Similarly, example computer executable methods described herein may be performed on computer 800. It is to be appreciated that other computers may also be employed with the example systems and methods described herein. In one example, the computer 800 may also include a configuration logic 830 that is configured to communicate with a posting server(s) and/or communication server(s) on behalf of an image forming device that may be connected to the computer 800 by an i/o port 810.

Thus, the configuration logic 830 may facilitate communicating setup data with an image forming device, selecting a communication server to provide an electronic communication distribution service for the image forming device and selecting a posting server to provide an alert posting service for the image forming device. The configuration logic 830 may also facilitate receiving a posting data associated with an alert, generating an electronic communication based on the posting data, and communicating the electronic communication to a communication server.

The processor 802 can be a variety of various processors including dual microprocessor and other multi-processor architectures. The memory 804 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the computer 800 via, for example, an input/output interface (e.g., card, device) 818 and an input/output port 810. The disk 806 can include, but is not limited to, devices like a magnetic disk drive, a solid state disk drive, a floppy disk drive, a tape drive, a Zip drive, a flash memory card, and/or a memory stick. Furthermore, the disk 806 can include optical drives like a compact disc ROM (CD-ROM), a CD recordable drive (CD-R drive), a CD rewriteable drive (CD-RW drive), and/or a digital video ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus or mesh architectures. The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with input/output devices 818 via i/o interfaces and input/output ports 810. Input/output devices 818 can include, but are not limited to, a keyboard, a microphone, a pointing and selection device, cameras, video cards, displays, disk 806, network devices 820, and the like. The input/output ports 810 can include but are not limited to, serial ports, parallel ports, and USB ports.

The computer 800 can operate in a network environment and thus may be connected to network devices 820 via the i/o devices 818, a network interface card 812, and/or the i/o ports 810. Through the network devices 820, the computer 800 may interact with a network. Through the network, the computer 800 may be logically connected to remote computers. The networks with which the computer 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth, and the like. Similarly, the network devices 820 can connect to WAN technologies including, but not limited to, point to point links, circuit switching networks like integrated services digital networks (ISDN), packet switching networks, and digital subscriber lines (DSL).

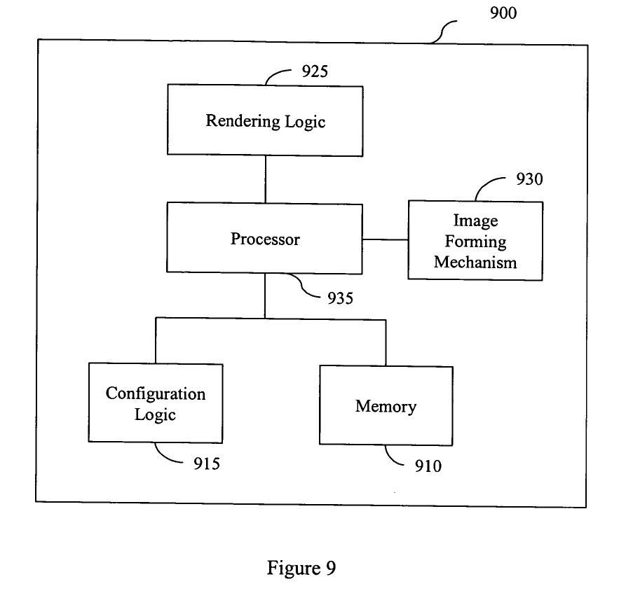

FIG. 9 illustrates an example image forming device 900 on which example systems and methods described herein may be implemented. The image forming device 900 may include a memory 910 configured to store print data, for example, or to be used more generally for image processing and/or configuration processing. When employed in configuration processing the memory 910 may store, for example, a configuration server address, a posting server address, and a communication server address. The image forming device 900 may also include a configuration logic 915 that facilitates communicating setup data between the image forming device 900 and a configuration server, configuring the image forming device 900 to process alerts and selectively communicating posting data between the image forming device 900 and the posting server.

The image forming device 900 may receive print data to be rendered. Thus, the image forming device 900 may include a rendering logic 925 configured to generate a printer-ready image from print data. Rendering varies based on the format of the data involved and the type of imaging device. In general, the rendering logic 925 converts high-level data into a graphical image for display or printing (e.g., the print-ready image). For example, one form is ray-tracing that takes a mathematical model of a three-dimensional object or scene and converts it into a bitmap image. Another example is the process of converting HTML into an image for display/printing. It is to be appreciated that the image forming device 900 may receive printer-ready data that does not need to be rendered and thus the rendering logic 925 may not appear in some image forming devices.

The image forming device 900 may also include an image forming mechanism 930 configured to generate an image onto print media from the print-ready image. The image forming mechanism 930 may vary based on the type of the imaging device 900 and may include a laser imaging mechanism, other toner-based imaging mechanisms, an ink jet mechanism, digital imaging mechanism, or other imaging reproduction engine. A processor 935 may be included that is implemented with logic to control the operation of the image-forming device 900. In one example, the processor 935 includes logic that is capable of executing Java instructions. Other components of the image forming device 900 are not described herein but may include media handling and storage mechanisms, sensors, controllers, and other components involved in the imaging process.

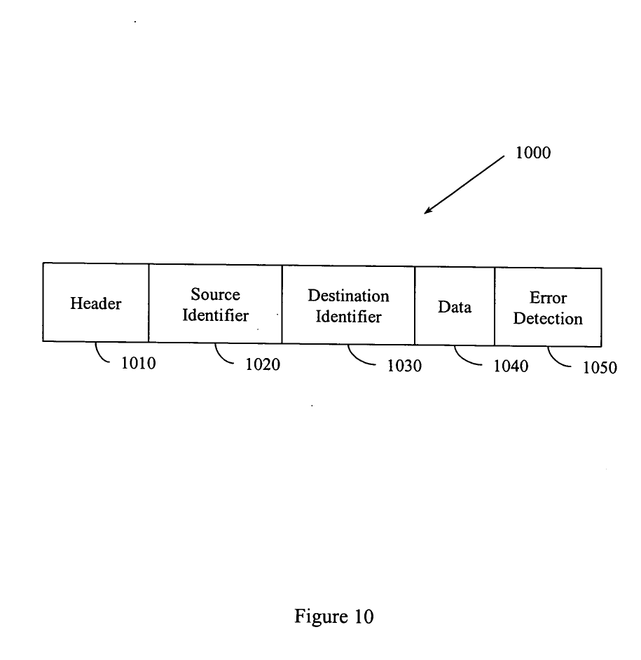

Referring now to FIG. 10, information can be transmitted between various devices associated with configuring a device to process alerts as described herein via a data packet 1000. An exemplary data packet 1000 is illustrated. The data packet 1000 includes a header field 1010 that includes information like the length and type of packet. A source identifier 1020 follows the header field 1010 and includes, for example, an address of the device from which the packet 1000 originated. Following the source identifier 1020, the packet 1000 includes a destination identifier 1030 that holds, for example, an address(es) of the device(s) to which the packet 1000 is ultimately destined. The data field 1040 in the packet 1000 includes various information intended for the receiving device. The data packet 1000 ends with an error detecting and/or correcting field 1050 whereby a device can determine if it has properly received the packet 1000. While five fields are illustrated in the data packet 1000, it is to be appreciated that a greater and/or lesser number of fields can be present in data packets and that the fields can be arranged in various orders.

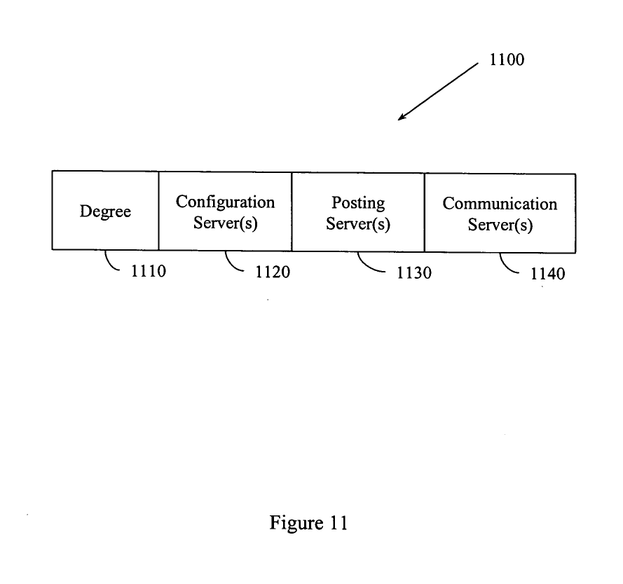

FIG. 11 illustrates sub-fields 1100 within the data field 1040 (FIG. 10). The sub-fields 1100 described are merely exemplary and it is to be appreciated that a greater and/or lesser number of sub-fields arranged in different orders could be employed with various types of data germane to automatic alert configuration. The sub-fields 1100 include a field 1110 that holds, for example, information concerning the degree to which an image forming device like a laser printer is to be automatically configured to process alerts.

The sub-fields 1100 may also include a field 1120 that stores, for example, the address(es) of a configuration server(s) that will participate in automatically configuring an image forming device. The addresses may include, for example, an ordered list of addresses of configuration servers arranged in an order that reflects user preferences for which configuration server(s) are to be employed.

The sub-fields 1100 may also include a field 1130 that stores, for example, the address(es) of a posting server(s) that will receive posting data from the image forming device and produce electronic messages (e.g., emails) from that posting data. The addresses may include, for example, a primary and secondary posting server.

The sub-fields 1100 may also include a field 1140 that stores, for example, the address(es) of a communication server(s) that will distribute the electronic communications produced by the posting server(s). The addresses may include, for example, communication servers located in various regions to handle messages intended for recipients in various regions.

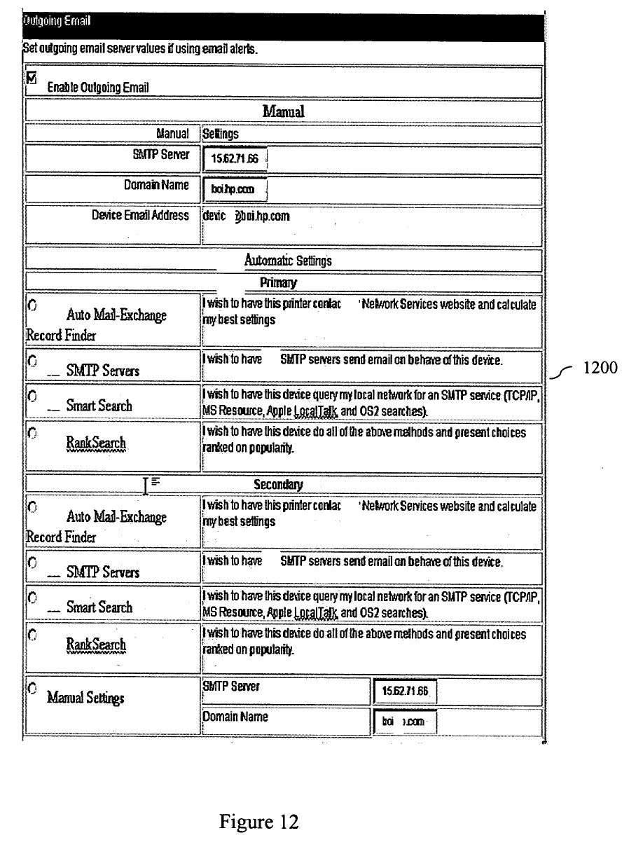

FIG. 12 illustrates a simulated screen shot 1200 of a portion of a user interface that can be employed to facilitate configuring an image forming device to process alerts. The simulated screen shot 1200 illustrates a section titled “Manual” where SMTP server information and the like can be entered manually. The simulated screen shot 1200 also illustrates a section titled “Automatic Settings” where a user can select the degree to which configuration is to be performed automatically. In one example, a user may indicate that they desire to have a network services website calculate the best possible settings for the printer. In another example, a user may indicate that they desire to have SMTP servers send emails on behalf of the printer. Similarly, in other examples, the user may indicate the type of actions to be performed automatically on the printer's behalf. While four choices are listed in the Automatic Settings section of the simulated screen shot 1200 it is to be appreciated that a greater and/or lesser number of choices may be presented.

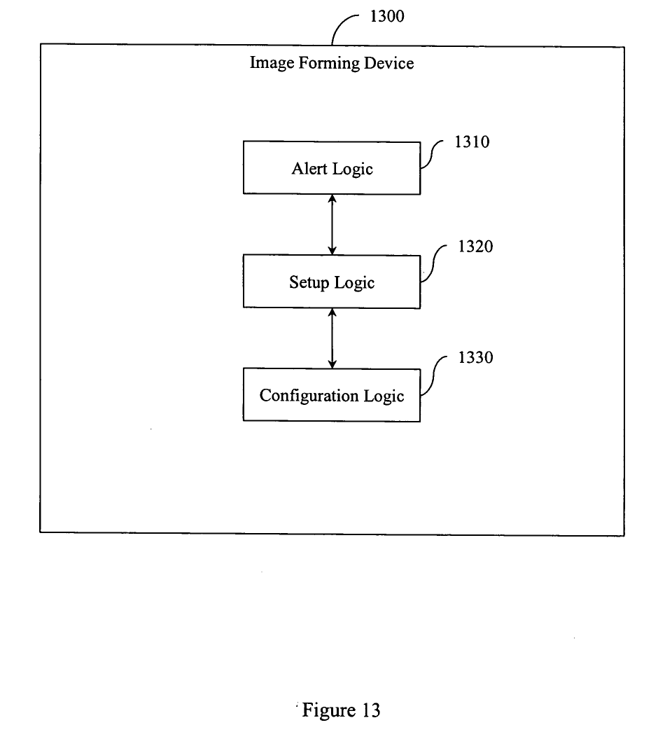

FIG. 13 illustrates an image forming device 1300. The image forming device 1300 includes an alert logic 1310 that may be configured to transmit alert data to a communication server. In one example, the alert logic 1310 transmits the alert data to the communication server through an intermediate posting server. The alert data may be sent in response to a device event.

The image forming device 1300 may also include a setup logic 1320 configured to determine (e.g., identify, negotiate with, interrogate) communication servers that are capable of distributing an electronic message related to the alert data being transmitted. The image forming device 1300 may also include a configuration logic 1330 that may be configured to automatically (re)configure the alert logic 1310 to transmit the alert data to the communication servers determined by the setup logic 1320. For example, the configuration logic 1330 may change parameters, addresses, settings, logical switches, physical switches and so on in the alert logic 1310. By way of illustration, the alert logic 1310 may initially be configured to send alert data to a first communication server by way of a first posting server. However, the posting server and/or communication server may experience difficulties that impact alert delivery. Thus, the setup logic 1320 may determine other communication servers and/or posting servers to service the alert distribution and the configuration logic 1330 may reconfigure the alert logic 1310 to reflect these new determinations. Some systems may have required manual setup of the initial addresses and may have required manual reconfiguration of addresses to handle run time changes (e.g., communication server crash). However, users may not have been willing and/or able to perform these manual (re)configuration operations.

In one example, the setup logic 1320 may be configured to execute periodically. Thus, the setup logic 1320 may periodically search for, interrogate, and/or negotiate with servers. Based on the periodic execution, the setup logic 1320 may determine that different servers should be employed to support alert processing. Thus, the configuration logic 1330 may be signaled by the setup logic 1320 following a periodic execution that yields a suggested reconfiguration. In another example, the setup logic 1320 may be configured to execute in response to an image forming device being powered on and/or reset.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A computer-readable medium storing processor executable components and processor readable data that facilitate configuring an image forming device to process alerts, comprising:
a data store configured to store an address of one or more of, a configuration server, a posting server, and a communication server;
a setup logic configured to communicate a setup data for configuring one or more of, the image forming device, and the configuration server, where the setup data is communicated between the image forming device and the configuration server whose address is stored in the data store; and
a configuration logic configured to automatically configure the image forming device to process alerts handled by one or more of, the image forming device, the posting server, and the communication server based, at least in part, on the setup data.

2. The computer-readable medium of claim 1, where:
the setup logic comprises Java instructions configured to communicate the setup data; and
the configuration logic comprises Java instructions configured to automatically configure the image forming device.

3. The computer-readable medium of claim 2, where the image forming device employs a JVM to process Java instructions.

4. The computer-readable medium of claim 1, including processor executable components and processor readable data of a posting logic configured to selectively communicate a posting data for communicating information associated with an alert between the image forming device and the posting server based, at least in part, on the setup data, where the address of the posting server is stored in the data store.

5. The computer-readable medium of claim 1, where the configuration logic is further configured to:
select a posting server with which a posting data for communicating information associated with the alert will be communicated and automatically configuring the image forming device to post the posting data to the posting server; and
select a communication server to distribute an electronic communication associated with the posting data and to automatically configure the image forming device to direct the posting server to utilize the communication server to distribute the electronic communication.

6. The computer-readable medium of claim 5, where the configuration logic is further configured to associate the alert with a device event.

7. The computer-readable medium of claim 6, where the device event concerns one or more of, a toner low state, a toner empty state, a paper jam state, an overheating state, a print job interrupted state, a print job completed state, an online state, and an offline state.

8. The computer-readable medium of claim 5, where the setup data includes one or more of, an alert type identifier, a set of alert recipient identifiers, an image forming device address, a posting server address, and a communication server address.

9. The computer-readable medium of claim 5, where the posting data includes one or more of, an alert type, an alert data, a set of alert recipient identifiers, an image forming device address, and a posting acknowledgment.

10. The computer-readable medium of claim 1, including processor executable components and processor readable data of a user interface logic configured to facilitate communicating configuration information between a user and the system.

11. An ASIC having stored thereon:
a data store configured to store an address of one or more of, a configuration server, a posting server, and a communication server;
a setup logic configured to communicate a setup data for configuring one or more of, an image forming device, and the configuration server, where the setup data is communicated between the image forming device and the configuration server whose address is stored in the data store; and
a configuration logic configured to automatically configure the image forming device to process alerts handled by one or more of, the image forming device, the posting server, and the communication server based, at least in part, on the setup data.

12. A computer-readable medium storing processor executable components and processor readable data that facilitate configuring an image forming device to process alerts, comprising:
a data store configured to store an address of the image-forming device to be automatically configured;
a setup logic configured to communicate a setup data for configuring one or more of, the image forming device, and a configuration server, where the setup data is communicated between the image forming device and the configuration server; and
a selection logic configured to:
select a posting server to provide an alert posting service for the image forming device based, at least in part, on the setup data;
automatically configure the image forming device to post a posting data for communicating information associated with an alert to the posting server;
select a communication server to provide an electronic communication distribution service for the image forming device based, at least in part, on the setup data; and
automatically configure the image forming device to direct the posting server to utilize the selected communication server.

13. The computer-readable medium of claim 12, where the alert is associated with a device event.

14. The computer-readable medium of claim 13, where the device event concerns one or more of, a toner low state, a toner empty state, a paper jam state, an overheating state, a print job interrupted state, a print job completed state, an online state, and an offline state.

15. The computer-readable medium of claim 12, where the setup data includes one or more of, an alert type identifier, a set of alert recipient identifiers, an image forming device address, a posting server address, and a communication server address.

16. The computer-readable medium of claim 12, where the posting data includes one or more of, an alert message type, an alert message data, a set of alert recipient identifiers, and an acknowledgment.

17. The computer-readable medium of claim 12 including processor executable components and processor readable data of a query logic configured to query the image forming device for non-alert posting data.

18. A system that facilitates configuring an image forming device to process alerts, comprising:
an enabled image forming device that includes an alert configuration logic configured to automatically configure the image forming device; and
a configuration server that includes a configuration logic that facilitates automatically configuring the image forming device to process alerts.

19. The system of claim 18, where the image forming device is configured to process Java instructions.

20. The system of claim 18, where the alert configuration logic comprises:
an image forming device memory configured to store an address of one or more of, a configuration server, a posting server, and a communication server;
an image forming device setup logic configured to communicate a setup data for configuring one or more of, the image forming device, and the configuration server between the image forming device and the configuration server; and
an image forming device configuration logic configured to automatically configure the image forming device to process alerts based, at least in part, on the setup data.

21. The system of claim 20, where the configuration logic includes:
a configuration server setup logic configured to communicate the setup data with the image forming device;
a configuration server selection logic configured to select a communication server to provide an electronic communication distribution service for the image forming device and to select a posting server to provide an alert posting service for the image forming device based, at least in part, on the setup data;
a configuration server translation logic configured to receive a posting data for communicating information associated with the alert and to generate an electronic communication based, at least in part, on the posting data; and
a configuration server communication logic configured to communicate the electronic communication to the communication server.

22. The system of claim 21, where the alert configuration logic is configured to:
establish a level of user interaction in a configuration process;
select a posting server with which the posting data will be communicated and automatically configure the image forming device to interact with the posting server; and
select a communication server to distribute an electronic communication associated with the posting data and to automatically configure the image forming device to direct the posting server to interact with the communication server.

23. A method for configuring an image forming device to process alerts, comprising:
communicating a startup data to a configuration server, the startup data identifying an image forming device;
automatically selecting, based at least in part on the startup data, a posting server and automatically configuring the image forming device to post an alert data to the posting server;
automatically selecting, based at least in part on the startup data, a communication server; and
automatically configuring the image forming device to direct the posting server to employ the communication server to distribute an electronic notification produced in response to the alert data being posted to the posting server.

24. The method of claim 23, where the startup data includes one or more of, a printer address, an alert type identifier, and a recipient email address.

25. The method of claim 23, where the alert data includes one or more of, an alert identifier, an alert type, an alert message, and an alert recipient.

26. The method of claim 23, where the electronic notification comprises an email message.

27. The method of claim 23, comprising:
determining a degree to which the image forming device is to be automatically configured by presenting an automatic configuration choice to a user.

28. A computer-readable medium storing processor executable instructions operable to perform a method, the method comprising:
communicating a startup data to a configuration server, the startup data identifying an image forming device;
automatically selecting, based at least in part on the startup data, a posting server and automatically configuring the image forming device to post an alert data to the posting server;
automatically selecting, based at least in part on the startup data, a communication server; and
automatically configuring the image forming device to direct the posting server to employ the communication server to distribute an electronic notification produced in response to the alert data being posted to the posting server.

29. A method for providing configuration information to an alert generating printer, comprising:
receiving a startup signal from the printer;
negotiating a level of automatic configuration service for the printer;
selecting a posting server to provide an alert posting service for the printer;
selecting a communication server to provide an electronic message distribution service for the printer; and
communicating to the printer a configuration data related to the posting server and the communication server.

30. The method of claim 29, comprising:
detecting a state change in one or more of, the posting server, and the communication server;
selecting one or more of, an alternate posting server and an alternate communication server; and
communicating to the printer a reconfiguration data related to one or more of, the state change, the alternate posting server, and the alternate communication server.

31. In a printer having a graphical user interface comprising a display and a selection device, a method of providing and selecting from a set of data entries on the display, the method comprising:
retrieving a set of data entries that represent a choice concerning how a printer should be configured to process alerts;
displaying the set of data entries on the display;
receiving a data entry selection signal indicative of the selection device selecting a selected data entry; and
in response to the data entry selection signal, initiating an operation associated with configuring the printer based on the selected data entry.

32. A data packet for transmitting data between an image forming device and an alert configuration server, comprising:
a first field that stores an address of an alert configuration server that facilitates automatically configuring the image forming device to process alerts;
a second field that stores an address of a posting server that will provide a posting service for the image forming device; and
a third field that stores an address of a communication server that will provide a communication service for the image forming device.

33. An image forming device, comprising:
an alert logic configured to transmit alert data to a communication server by way of a posting server in response to a device event;
a setup logic configured to determine a communication server capable of distributing an electronic alert message; and
a configuration logic configured to automatically re-configure the alert logic to transmit the alert data to the communication server determined by the setup logic.

34. The device of claim 33, where the setup logic is configured to execute periodically.

35. The device of claim 33, where the setup logic is configured to execute in response to the image forming device being powered on.

36. The device of claim 33, where the setup logic is further configured to determine a posting server capable of processing the alert data and where the configuration logic re-configures the alert logic to transmit alert data to the posting server and causes the posting server to transmit the alert data to the communication server.

37. A system, comprising:
means for communicating a configuration data with a configuration server; and
means for automatically configuring a printer for to process alerts based, at least in part, on the configuration data.
